(19) United States
(12) Patent Application Publication
(10) Pub. No.: US 2015/0279558 A1
(43) Pub. Date: Oct. 1, 2015

(54) DEVICE AND METHOD FOR POTTING COILS

(71) Applicant: SIEMENS AKTIENGESELLSCHAFT, München (DE)

(72) Inventors: Jörn Grundmann, Grossenseebach (DE); Peter Kummeth, Herzogenaurach (DE)

(21) Appl. No.: 14/435,098

(22) PCT Filed: Oct. 2, 2013
(86) PCT No.: PCT/EP2013/070506

§ 371 Date: Apr. 10, 2015

(30) Foreign Application Priority Data
Oct. 10, 2012 (DE) 10 2012 218 456.2

(51) Int. Cl. H01F 41/00; H01F 41/04

(52) U.S. Cl. CPC H01F 41/005; H01F 41/048

(57) ABSTRACT

A device for potting coils, in particular superconducting coils, and an operating method for said device are provided. The device comprises an outer potting container , a potting chamber for accommodating at least one coil to be potted, and a device for filling with potting mass. The outer potting container is lined with an inner potting container , the material of which has a diamond pyramid hardness number below 500 and a melting point between 45 degrees Celsius and 200 degrees Celsius. In the operating method, the shape of the inner potting container is achieved by mechanical or thermal processing, at least one coil to be potted is positioned in the potting chamber, a potting mass is filled into the remaining hollow space in the potting chamber, the potting mass is hardened, and the potted coil is removed from the device.

### CROSS REFERENCE TO RELATED APPLICATIONS

This application is the US National Stage of International Application No. PCT/EP2013/0070506 filed Oct. 2, 2013 and claims benefit thereof, the entire content of which is hereby incorporated herein by reference. The International Application claims priority to the German application No. 10 2012 218456.2 DE filed Oct. 10, 2012, the entire contents of which is hereby incorporated herein by reference.

### FIELD OF INVENTION

The present invention relates to a device for potting electrical coils, in particular superconducting coils, and to an operating method for said device.

### BACKGROUND OF INVENTION

Electrical coils are manufactured for use in electric machines, especially in motors and generators which comprise one or more wound coil conductors and which are potted with a potting mass. In particular superconducting coils are manufactured from a number of layers of wound coil conductors made of superconducting material, which are embedded in a hardened potting mass based on epoxy/amine or epoxy acid anhydride.

Coils which will withstand high rotational speeds in the range of 3600 revolutions per minute and have large lateral dimensions in the range of 1 m by 4 m are needed for use in power station generators. Because of the high centrifugal forces occurring, said coils must be mechanically very stable. In addition the coils must be a very accurate fit and must possess very accurately dimensioned outer contours, wherein the required tolerances lie in the range of 100 gm. With previously known potting methods these tolerance values could only be achieved by subsequent processing of the potted coil. However such post-processing is not suitable for the manufacture of a superconducting coil since the superconducting materials, especially the ceramic high-temperature superconductors, are very sensitive to mechanical stresses. A further difficulty is releasing the potted coil from the potting mold, since with the known potting methods a mechanical stress on the coil likewise occurs, which can easily lead to damage to the superconducting materials. In the light of the high costs of superconducting coils such mechanical damage is absolutely to be avoided.

### SUMMARY OF INVENTION

The object of the present invention is to make available a device for potting coils, especially superconducting coils, which avoids the stated disadvantages. A further object of the invention is to specify an operating method for said device.

This object is achieved by the device and by the method described in claims.

The inventive device for potting coils comprises an outer potting container, a potting chamber for accepting at least one coil to be potted and a device for filling the chamber with potting mass. The outer potting container is lined with an inner potting container of which the material has a diamond pyramid hardness below 500 and a melting point of between 45 degrees Celsius and 200 degrees Celsius.

The outer potting container of this device can be manufactured more easily and at lower cost than previous devices, since the quality and accuracy of the surface of the potted coil is only defined by the properties of the inner potting container. The inner potting container can be manufactured at low cost for example by filling the inner potting container with the molten material and subsequent hollowing out. Advantageously the diamond pyramid hardness of the material of the inner potting container lies below 200, especially advantageously below 50. The melting point of the material of the inner potting container advantageously lies below 120 degrees Celsius.

In the inventive operating method for the inventive device the molding of the inner potting container is achieved by mechanical or thermal processing. Furthermore at least one coil to be potted is positioned in the potting chamber, the remaining hollow space in the potting chamber is filled with a potting mass and the potting mass is hardened. Finally the potted coil is released from the device. The inventive operating method advantageously makes it possible to manufacture coils, especially superconducting coils, with more accurate production tolerances than with known methods. This is achieved by the simple processing of the material of the inner potting container, so that a subsequent processing of the potted coil can be avoided. The low hardness of the material of the inner potting container enables it to be processed in a simple manner by shaving or milling with a milling machine for example. Small changes in the dimension or requirements of the potted coil can advantageously be implemented by changes in the processing of the internal potting container, without changes to the external potting container being necessary. Furthermore the mechanical stress during release of the potted coil is greatly reduced compared to known potting methods, since a soft and easily-meltable material is used for the inner potting container. This makes it possible to manufacture coils with dimensions of several meters with precise tolerances and high process yields. No compromises are necessary in the shape of the molded coil in respect of easier mechanical release, for example the use of sloping walls not desirable for the coil in subsequent use.

Advantageous embodiments and developments of the inventive device emerge from the dependent claims. Accordingly the device can additionally have the following features:

The material of the inner potting container can be a solid mixture of aliphatic hydrocarbons. In particular the material can be a paraffin or a micro wax. The use of these materials allows the inner potting container to be manufactured at an especially low cost. In addition paraffins and micro waxes are neutral in environmental terms and can be reused multiple times. The water-repelling and insulating properties of paraffins and micro waxes mean that any residue present on the surface of the potted coil does not have a disadvantageous effect.

The potting mold can include a cover. Thus the potting mold, after the coil has been placed in the potting chamber, can be closed with the aid of the cover. The cover is able to be connected via a seal to the outer potting container.

The cover can be coated with a separation layer, especially with the material PTFE. This facilitates the release of the cover from the potted coil and the opening of the cover after potting.

The device can be equipped with a heating device, a temperature sensor and a regulation device, which regulates the temperature on the basis of measured values of the temperature sensor.

The device can be equipped with a device for evacuating and/or ventilating the potting chamber. This allows the potting and the hardening of the potting material to be carried out in a vacuum and also allows the potting chamber to be ventilated before the cover is opened.

The device can be equipped with a drain device for blowing out the material of the inner potting container.

The potting chamber of the device can have the shape of a loop, meaning that it can possess a two-part contiguous topology, so that the potting chamber is especially suitable for a accepting one or more coils. In this case the inner potting container and the outer potting container each have an inner and an outer wall.

Advantageous embodiments and developments of the inventive operating method emerge from the dependent claims. Accordingly the method can have the following additional features:

After hardening of the potting mass the inner potting container, for releasing the potted coil, can be liquefied or softened by heating it to a temperature of between 45 degrees Celsius and 225 degrees Celsius. This allows an especially gentle release of the potted coil from the device so that a mechanical stress on the coil during release is largely avoided.

In this case the liquefied or softened potting mass can be let out by the drain device.

The outer potting container can be lined several times with the material of the inner potting container and be used with each inner potting container manufactured in this way for carrying out a potting. This principle re-use of the outer potting container any number of times allows the method to be carried out at especially low cost, since the costs for the outer potting container are typically significantly higher than the costs for the inner potting container.

The coil to be potted can be positioned in the potting chamber of the device on at least one spacer. This allows a comprehensive potting of the coil with the potting material so that the wound coil conductors are largely protected against external mechanical, chemical and electrical influences.

A number of individual coils can be positioned in the potting chamber of the device and potted jointly into a coil body. In such cases at least one spacer can be positioned between the coils.

The potting chamber of the device can be evacuated before or after it is filled with the potting mass.

### BRIEF DESCRIPTION OF THE DRAWINGS

The invention is described below on the basis of a preferred exemplary embodiment which refers to the appended schematic drawings, in which:

FIG. 1 shows a potting mold for potting superconducting coils in a schematic view and

FIG. 2 shows a cross-section through sectional plane II in FIG. 1, which illustrates the structure of the potting mold in more detail.

### DETAILED DESCRIPTION OF INVENTION

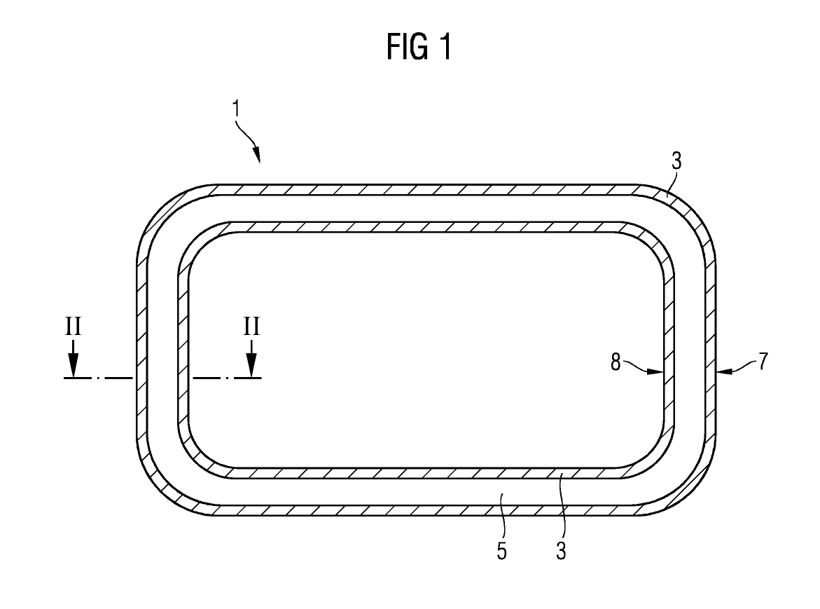

FIG. 1 shows by way of example the view of a potting mold 1 for potting a superconducting rectangular coil. In this view, for the sake of clarity only the most conspicuous components are shown, namely the outer potting container 3 and the potting chamber 5, which is adapted in its shape to the racetrack coil to be potted. In this example the outer potting container 3 has an outer wall 7 and an inner wall 8, so that a free hollow space is produced in the middle. Other examples for potting molds are also conceivable in which no inner wall exists and the potting chamber 5 consists of a single contiguous volume. As an alternative to the shape of a rounded rectangle shown, the shapes of the potting chamber can for example also be annular or oval. In the preferred exemplary embodiment the outer potting container 3 is made of aluminum, which is suitable as a massive, stable-shape material for the manufacturing of such molds.

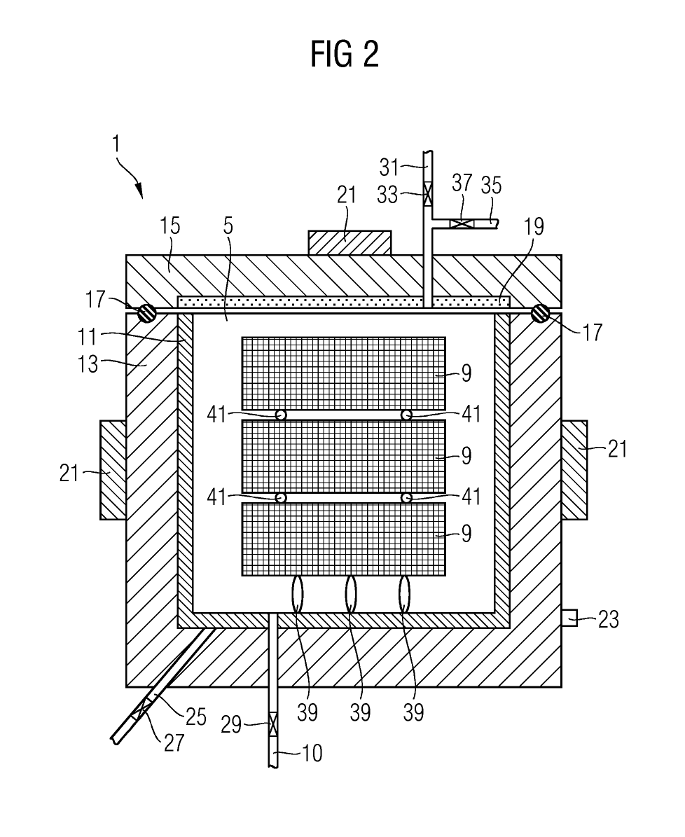

FIG. 2 shows a cross-section of a part of the potting mold 1 in accordance with sectional plane II in FIG. 1, in which the structure of the potting mold 1 can be seen in more detail and in which the potting chamber 5 is filled with an arrangement of coils 9. As can be seen in this cross-section, the potting mold 1 has an outer potting container 13 and a cover 15, which are able to be connected to one another via a seal 17. In particular the seal 17 prevents the intrusion and escape of gases and the escape of resin during potting. In this example the seal 17 is an O-ring made of rubber. The outer potting container 3 is aligned with an inner potting container 11, of which the material in this exemplary embodiment is a hard paraffin with a melting point of 55 degrees Celsius. The inner potting container 11 can be manufactured for example by completely filling the outer potting container 3 with melted hard paraffin and subsequently hollowing out the inner space. The average layer thickness of the inner potting container 11 is in this example 2 mm, wherein adherence to the precise manufacturing tolerances which lie in the range of 100 μm is achieved by local deviations from the average layer thickness. The post processing of the inner potting container 11 for achieving the required geometry and surface quality can be done for example with a milling machine with a cooled milling head.

The potting chamber 5 is equipped in the example shown with three coils 9, wherein the coils 9 are held separated by a number of first spacers 39 from the inner potting container 11 and the coils 9 are held separated from one another by a number of second spacers 41. The result achieved by this is that even the majority of the lower coil is surrounded by potting mass in that the space between the coils is filled with potting mass. In addition to the second spacers 41 shown here, cooling plates, especially made of copper, can also be fitted for improving the cooling of the coils. In the example shown a device 10 for filling with potting mass is present through which the potting chamber 5 is connected to a reservoir of the potting mass not shown here via a potting mass valve 29. The potting mass can for example be a mixture of an epoxy resin and amine, which after production of the mixture hardens after a few hours at room temperature. In addition the device shown has a vacuum connection 31 through which the potting chamber 5 can be evacuated via a vacuum valve 33. After potting of the coils 9 the potting chamber can be filled again with their through the air connections 35 via a ventilation valve 37 or also have overpressure applied to it during the hardening of the potting mass. As an alternative filling with another gas or gas mixture is also possible.

The device of the exemplary embodiment shown is further equipped with heating devices 21, a temperature sensor 23 and a regulation device not shown here, which on the basis of measured values of the temperature sensor 23, regulates the temperature of the outer potting container 3. The heating devices 21 are realized in this example as a heater with an electric heating filament and the temperature sensor 23 is a thermal element or a Pt100 temperature sensor. After the potting of the coils 9, this enables the temperature of the outer potting container 3 to be increased far enough for the hard paraffin of the inner potting container 11 to melt and the potted coils can be taken out of the potting mold after the cover 15 is opened. The cover 15 is provided in this example with a separation layer 19 which consists of PTFE. This separation layer 19 facilitates the release of the cover 15 from the potted coils 9 and thus the opening of the cover 15 after the potting. As an alternative the cover 15 can also be coated with the material of the inner potting container 11, i.e. with hard paraffin for example, or can consist entirely of a material with non-adhesive surface properties, i.e. completely of paraffin or PTFE for example.

In this exemplary embodiment the potting mold is further provided with a drain facility 25, through which the molten material of the inner potting container 11 can be let out via the drain valve 29. Subsequently the potted coils 9 can be taken out of the potting chamber 5 without any great mechanical stress. This especially gentle method of releasing the potted coils also has the advantage that the walls of the potting mold do not have to be embodied conically in order to make release at all possible. Thus no disadvantageous effects of the potting method on the geometrical form of the potted coil are produced here. Finally many potting processes can be carried out with the potting mold shown. It is merely necessary in each manufacturing process to manufacture a new inner potting container 11 and possibly adapt it by any post-processing necessary to the updated geometrical requirements that might be necessary for the respective time.

1-15. (canceled)

16. A potting coil device, comprising:
an inner potting container comprising a material with a diamond point hardness of 500 and a melting point of between 45 degrees Celsius and 200 degrees Celsius;
an outer potting chamber aligned with the inner potting chamber;
a potting chamber adapted for accepting a coil to be potted; and
a device for filling the chamber with potting mass.

17. The device as claimed in claim 16,
wherein the material of the inner potting container is a solid mixture of aliphatic hydro-carbons.

18. The device as claimed in claim 16, comprising:
a cover; and
a seal,
wherein the outer potting container and the cover are connected to one another via the seal.

19. The device as claimed in claim 18,
wherein the cover is coated with a separation means.

20. The device as claimed in claim 16, comprising:
a heating device;
a temperature sensor;
wherein the temperature of the heating device is regulated on the basis of measured values of the temperature sensor.

21. The device as claimed in claim 16, comprising:
a drainage device adapted for draining the material of the inner potting container.

22. The device as claimed in claim 16, comprising:
a device adapted for evacuating and/or ventilating the potting chamber.

23. The device as claimed in claim 16,
wherein the potting chamber is in the shape of a loop and the inner potting container and the outer potting container each comprise an inner wall and an outer wall.

24. A method for potting coils with a device as claimed in claim 16,
potting a least one coil in the potting chamber; and
filling a remaining hollow space in the potting chamber with a potting mass after the coil has been potted;
hardening the potting mass; and
releasing the potted coil from the device,
wherein the molding of the inner potting container is achieved by mechanical or thermal processing.

25. The method as claimed in claim 24, wherein the releasing includes:
heating the inner potting container to a temperature of between 45 degrees Celsius and 225 degrees Celsius, wherein the heating liquefies or softens the inner potting soil in order to release the potted coil.

26. The method as claimed in claim 25, comprising:
draining in the liquefied or softened material of the inner potting container a drainage device.

27. The method as claimed in claim 24,
wherein the outer potting container is lined multiple times with the material of the inner potting container and in which each inner potting container is used for carrying out a potting.

28. The method as claimed in claim 24,
positioning the coil to be potted in the potting chamber of the device on a first spacer to separate the potted coil from the inner potting container.

29. The method as claimed in claim 24,
wherein a plurality of coils are potted, and
wherein between each of the potted coils by a second spacer is positioned to separated the respective potted coils from each other.

30. The method as claimed in claim 24,
evacuating the potting chamber of the device is evacuated before the chamber has been filled with the potting mass.

31. The method as claimed in claim 24,
evacuating the potting chamber of the device is evacuated after the chamber has been filled with the potting mass.
